(19) United States
(12) Patent Application Publication
(10) Pub. No.: US 2014/0189343 A1
(43) Pub. Date: Jul. 3, 2014

(54) SECURE INTERNET PROTOCOL (IP) FRONT-END FOR VIRTUALIZED ENVIRONMENTS

(71) Applicant: James Heit, Roseville, MN (US)

(72) Inventor: James Heit, Roseville, MN (US)

(21) Appl. No.: 13/732,002

(22) Filed: Dec. 31, 2012

(51) Int. Cl. H04L 29/06

(52) U.S. Cl. CPC H04L 63/0471
USPC 713/153

(57) ABSTRACT

An IPSec front-end may be configured to encrypt, decrypt and authenticate packets on behalf of a host on an insecure network and a peer on a secure network. For example, the IPSec front-end may receive internet protocol (IP) packets from the host and encrypt the data and format the data as an internet protocol security (IPsec) packet for transmission to the peer. When the peer responds with an IPSec packet, the IPSec front-end may decrypt the data and format the data as an IP packet. The IPSec front-end may be software executing on a Linux server.

### FIELD OF THE DISCLOSURE

The instant disclosure relates to computer networks. More specifically, this disclosure relates to securing computer networks.

### BACKGROUND

Internet Protocol Security (IPsec) is a complex set of protocols, defined by IETF standards, that provides network layer security by encrypting, decrypting, and authenticating Internet protocol (IP) packets. However, IPsec is a relatively new protocol, compared to the Internet Protocol (IP). Thus, existing devices may support IP communications, but not IPsec communications. These devices may be introduced into secure networks and a method and system may be desired to allow these IP devices to interact through IPsec in a secure network.

### SUMMARY

IPsec and IKE processing may be off-loaded from the devices to an IPSec front-end. The IPsec front-end creates a border between a non-secure network containing the IP device and a secure network containing IPsec devices. To an IPSec peer, the host system will appear to support IPSec and IKE protocols, while to the hosted device(s), a peer will seem to be sending traffic in the clear. The IPSec front-end may have no IP addresses assigned to its interfaces, and thus may be considered part of the attached hosts rather than a separate device.

According to one embodiment, a method includes receiving, by an IPSec front-end, clear text data formatted in an internet protocol (IP) packet from a host. The method also includes stripping, by the IPSec front-end, of network addressing information from the clear text data. The method further includes encrypting and authenticating, by the IPSec front-end, the clear text data. The method also includes formatting, by the IPSec front-end, the encrypted data into a secure IP (IPsec) packet by reattaching of the previously stripped network addressing information.

According to another embodiment, a computer program product including a non-transitory computer-readable medium having code to receive, by the IPSec front-end, clear text data formatted in an internet protocol (IP) packet from a host. The medium also includes code to strip, by the IPSec front-end, network information from the clear text data. The medium further includes code to encrypt and authenticate, by the IPSec front-end, the clear text data. The medium also includes code to format, by the IPSec front-end, the encrypted data into a secure IP (IPsec) packet.

According to yet another embodiment, an apparatus includes a memory, a network interface, and a processor coupled to the memory and the network interface. The processor is configured to receive, through the network interface, clear text data formatted in an internet protocol (IP) packet from a host. The processor is also configured to strip, through the network interface, network address information from the clear text data. The processor is further configured to encrypt and authenticate, through the network interface, the clear text data. The processor is also configured to format, through the network interface, the encrypted data into a secure IP (IPsec) packet.

According to one embodiment, a method includes receiving, by an IPSec front-end, encrypted and authenticated IPsec messages formatted in an interim protocol (IP) packet from a network peer. The method also includes stripping, by the IPsec front-end, of network addressing information from the network input. The method further includes decrypting and authenticating network input, by the IPsec front-end, and reformatting the data into a clear text packet by reattaching the previously stripped network addressing information to the data.

According to another embodiment, a computer program product includes a computer-readable memory having code to receive, by an IPSec front-end, encrypted and authenticated IPsec messages formatted in an internet protocol (IP) packet from a network peer. The medium also includes code to strip, by the IPsec front-end, of network addressing information from the network input. The medium further includes code to decrypt and authenticate network input, by the IPsec front-end, and reformat the data into a clear text packet by reattaching the previously stripped network addressing information to the data.

According to yet another embodiment, an apparatus includes a memory, a network interface operating as an IPsec front-end, and a processor coupled to the memory and the network interface. The processor is configured to receive, by the IPSec front-end, encrypted and authenticated IPsec messages formatted in an internet protocol (IP) packet from a network peer. The processor is also configured to strip, by the IPsec front-end, of network addressing information from the network input. The processor is further configured to decrypt and authenticate network input, by the IPsec front-end, and reformat the data into a clear text packet by reattaching the previously stripped network addressing information to the data.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an IPSec front-end between a secure network and an insecure network according to one embodiment of the disclosure.

FIGS. 2A and 2B are flow charts illustrating a method for bridging a secure and unsecure network according to one embodiment of the disclosure.

FIG. 3A is a block diagram illustrating IKE network-side protocol flow according to one embodiment of the disclosure.

FIG. 3B is a block diagram illustrating IKE host-side protocol flow according to one embodiment of the disclosure.

FIG. 4A is a block diagram illustrating IPsec data output flow according to one embodiment of the disclosure,

FIG. 4B is a block diagram illustrating IPsec data input flow according to one embodiment of the disclosure.

FIG. 5A is a block diagram illustrating name resolution for an IPSec front-end via an attached host when security considerations preclude assigning IP addresses to bridge interfaces according to one embodiment of the disclosure.

FIG. 5B is a call diagram illustrating domain name resolution for an IPSec front-end according to one embodiment of the disclosure.

FIG. 6A is a block diagram illustrating a situation in which a host transmits a packet, which after processing by the IPSec front-end, would exceed a max transmission unit according to one embodiment of the disclosure.

FIG. 6B is a block diagram illustrating a situation in which a host transmits a packet having a size exceeding a max transmission unit on a secure network according to one embodiment of the disclosure.

FIG. 7 is a block diagram illustrating a computer network according to one embodiment of the disclosure.

FIG. 8 is a block diagram illustrating a computer system according to one embodiment of the disclosure.

FIG. 9A is a block diagram illustrating a server hosting an emulated software environment for virtualization according to one embodiment of the disclosure.

FIG. 9B is a block diagram illustrating a server hosting an emulated hardware environment according to one embodiment of the disclosure.

### DETAILED DESCRIPTION

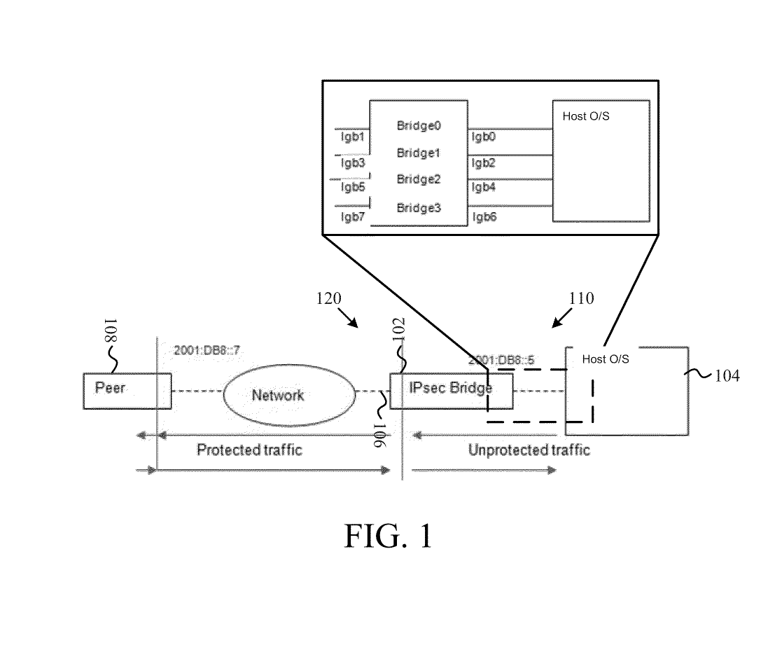

FIG. 1 is a block diagram illustrating a bridge between a secure network and an insecure network according to one embodiment of the disclosure. An IPSec front-end 102 may be, for example, an implementation of the FreeBSD native IPsec modified to operate in bridge mode. One or more IP devices, such as network interface cards (NICs) of a host 104, may be connected to a host-side 110 of the IPSec front-end 102. One or more network interfaces 106 of the IPSec front-end 102 may be connected to a network-side 120 containing a peer 108. The network-side 120 may contain traffic protected by IPsec. The host-side 110 will contain unprotected traffic, such as IP packets. Devices connected on the host-side 110 may be a limited set of trustworthy devices, such as an O/S 2200 device. The network-side 120 may be connected to a network of devices, including a peer 108 communicating with the host 104.

In one embodiment, traffic is not addressed to an interface on the bridge 102. That is, the bridge 102 may have no IP addresses, IP route or neighbor tables pertaining to the bridged interfaces 104 and 106. The host 104 may determine the destination IP and media access (MAC) addresses without knowledge of the bridge 102. The bridge 102 may snoop incoming and/or outgoing packets to the host-side 110 to determine MAC and/or IP addresses and identify packets for IPsec conversion.

According to another embodiment, the IPSec front-end 102 may be assigned a broadcast destination MAC address to receive communications from the host 104. For example, control messages may be transmitted from the host-side 110 having the broadcast destination MAC address. Control messages may include, for example, messages setting new policies for determining packets to encrypt and reformat at IPsec packets.

All traffic not specified to be encrypted between the host-side 110 and the network-side 120 may be passed through the IPSec front-end transparently. A policy configured on the bridge 102 may specify particular traffic as PROTECT (to encrypt/decrypt traffic), DROP (to ignore traffic) or PASS (to transparently relay traffic). For example, IPv6 unicast traffic may be configured as PROTECT. According to one embodiment, neighbor discovery protocol packets may be passed transparently through the bridge 102.

When a packet is identified as PROTECT, the IPSec front-end 102 may split Ethernet headers from the received packet, whether received from both the network-side 120 of the host-side 110. Then, IPsec processing may be performed on the packet. For example, IPsec may be removed from packets on reception from the network-side 120 and applied to packets on reception from the host-side 110. After the data is encrypted or decrypted, the Ethernet headers and addresses may be reapplied and the packet forwarded.

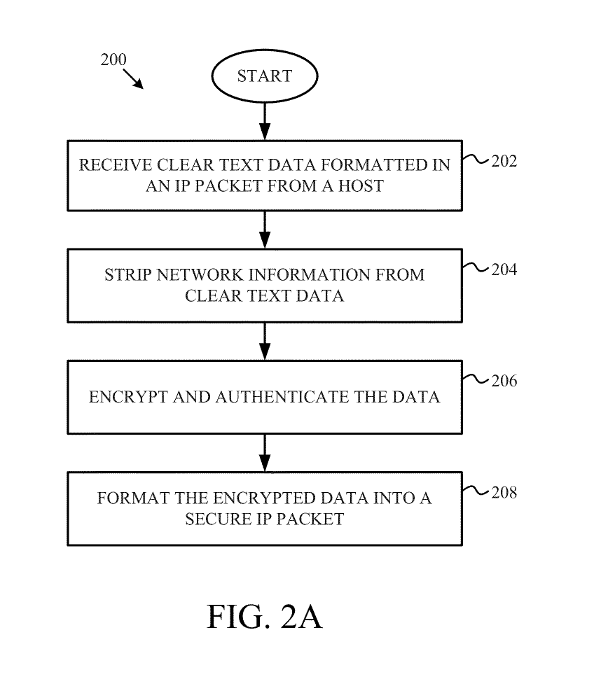

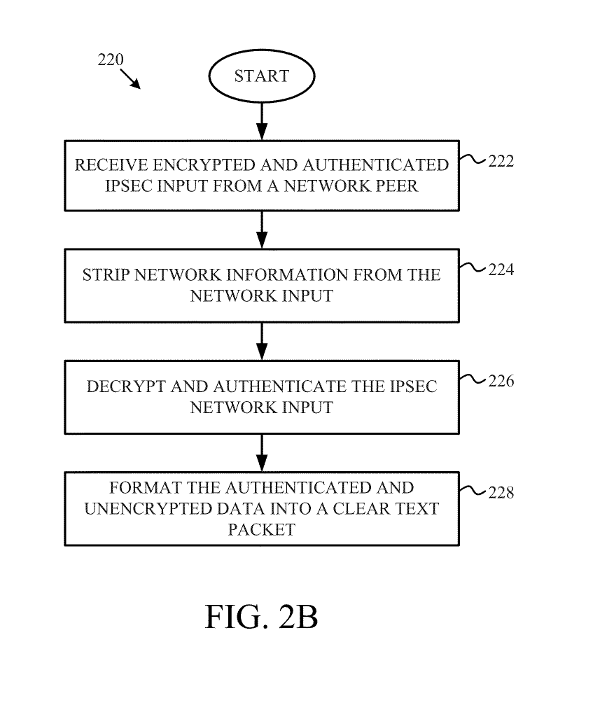

FIG. 2 is a flow chart illustrating a method for bridging a secure and insecure network by receiving unencrypted and unauthenticated packets according to one embodiment of the disclosure. A method 200 begins at Hock 202 with receiving, by an IPSec front-end from an attached host, clear text data formatted in an IP packet. The host may be an application or device executing within a virtualized environment. The virtualized environment may be executing on physical hardware that is executing an application serving as the bridge. For example, the physical hardware may be a Linux server with a network interface configured as an IPSec front-end and a virtualized environment hosting the host.

At block 204, network address information is stripped, by the bridge, from the clear text data received from the host. At block 206, the data is encrypted and authenticated by the IPSec front-end. At block 208, the encrypted data is formatted, by the IPSec bridge, into a secure IP packet.

FIG. 2B is a flow chart illustrating a method for bridging a secure and insecure network by receiving encrypted and authenticated packets according to one embodiment of the disclosure. A method 220 begins at block 222 with receiving, by an IPsec front-end from a remote peer, an encrypted and authenticated IPsec packet. At block 224, network address information may be stripped, by the bridge, from the IPsec packet received from the network. At block 226, the IPsec packet may be decrypted and authenticated by the IPsec front-end. At block 228, the clear text data plus stripped network information may be formatted by the IPsec front-end into a dear text IP packet.

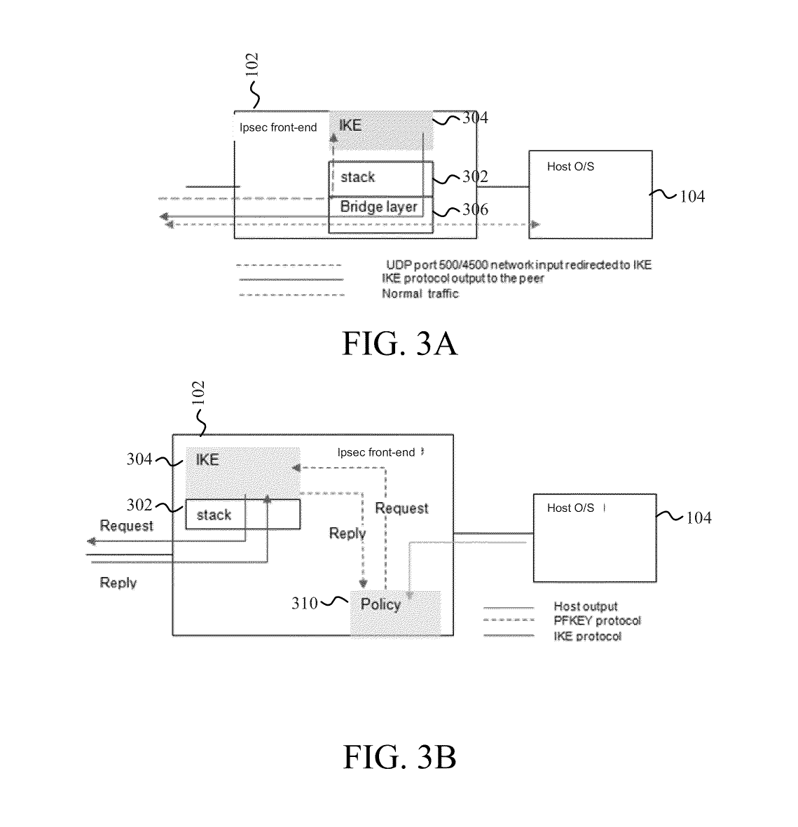

FIG. 3A is a block diagram illustrating network input IKE protocol flow according to one embodiment of the disclosure. The IPSec front-end 102 may detect network input interim key exchange (IKE) protocol, for example on UDP port 500 or port 4500. The bridge 102 may redirect the traffic through a protocol stack 302 to IKE layer 304. Address information, such as host MAC and IP addresses, stripped at the bridging layer 306 may be passed with the packet. After processing in the IKE layer 304, data may be transmitted through the stack 302 and the bridging layer 306 to the destination peer.

FIG. 3B is a block diagram illustrating IKE host-side protocol flow according to one embodiment of the disclosure. Each unicast output packet from the host 104 may be classified by a policy module 310 to determine if the packet is to be protected, passed through, or dropped. If the packet is to be protected, and there is no existing IPsec connection, an IKE protocol exchange may be initiated by the IKE, layer 304 of the IPSec front-end 102 with a peer (not shown).

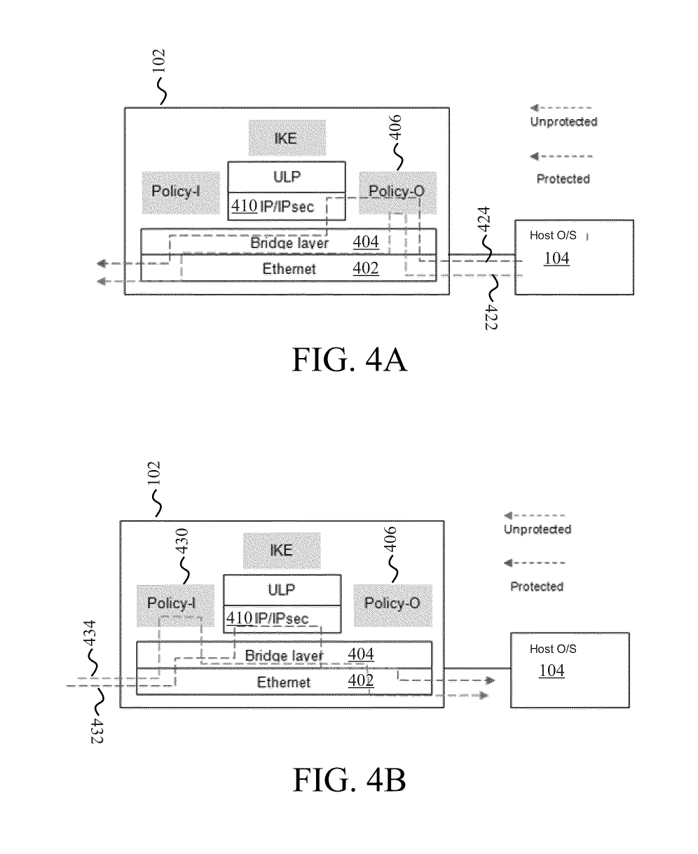

FIG. 4A is a block diagram illustrating data output flow according to one embodiment of the disclosure. An IPSec front-end 102 may include an Ethernet interface 402 coupled to a bridging layer 404. Although Ethernet is illustrated for the interface 402, the interface 402 may be any physical connector such as 10 Base2, 10 BaseT, fiber optic, and the like. An output policy 406 may determine which packets transmitted by the host 104 are encrypted for transmission to a peer (not shown). For example, certain packets 422 may pass through the IPSec front-end 102 without any processing on the packets outside of the Ethernet interface 402 and the bridging layer 404. Other packets 424 may match criteria within the output policy 406 and be directed to an IPsec module 410 for processing. The IPsec module 410 may strip the IP packet information, encrypt and authenticate the data, and reformat the encrypted data as an IPsec packet. In other embodiments, the IP packet information may be stripped and the IPsec packet reformatted in the bridging layer 404 or the Ethernet interface 402. The IPSec front-end 102 may also include other upper layer protocol (IMP) modules and an IKE module for establishing IPsec connections with the peer.

FIG. 4B is a block diagram illustrating data input flow according to one embodiment of the disclosure. Packets 432 and 434 may be inbound to the IPSec front-end 102 from a peer (not shown) destined for the host 104. Certain packets 434 may be examined by an input policy module 430 after processing in an Ethernet interface 402 and a bridge layer 404. The policy module 430 may determine the packet may pass through the IPSec front-end 102 by transmitting the packet to the host 104. Other packets 432 may match criteria in the policy module 430 for decrypting and reformatting before passing data from the packets 432 to the host 408.

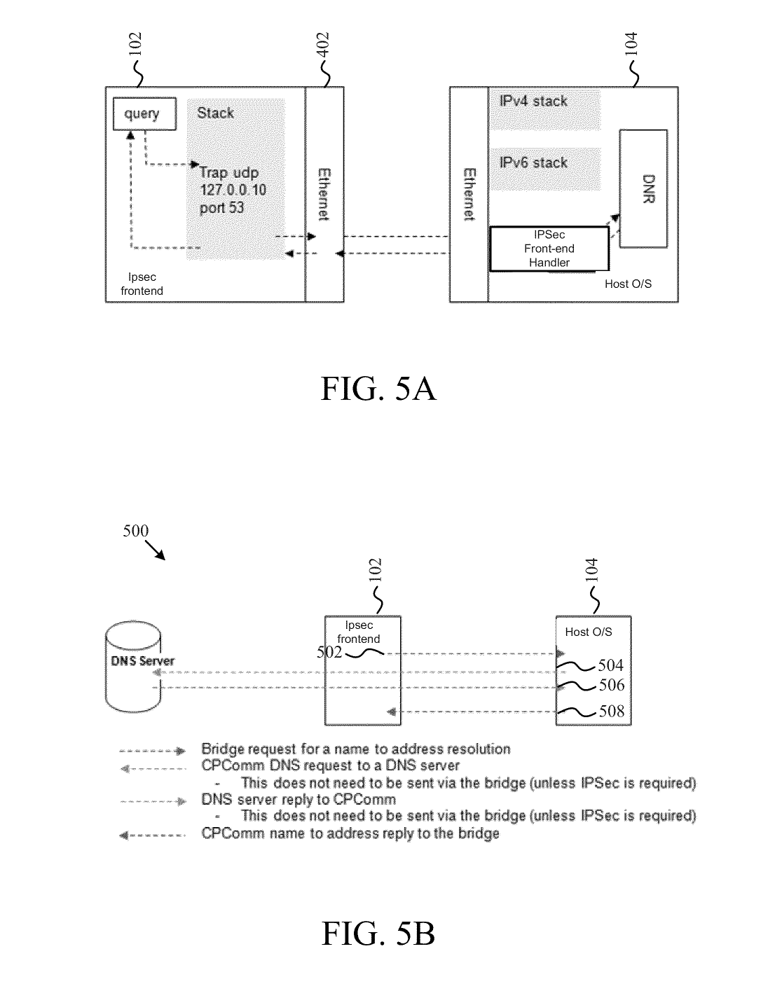

FIG. 5A is a block diagram illustrating name resolution for an IPSec front-end according to one embodiment of the disclosure. IPsec policy configuration stored on the IPSec front-end 102 may include machine names to be resolved to an address. The resolution may occur, for example, during IPsec startup or when a new peer name is added dynamically to the policy. When the IPSec front-end 102 does not participate in IP protocol exchanges due to security considerations, domain name service (DNS) name-to-address resolution may be achieved by the IPSec front-end 102 by sending queries to a DNS server in the host 104, which may resolve the name on behalf of the IPSec front-end.

A special address, such as 127.0.0.10, may be configured as a DNS server address within the IPSec front-end 102. This address and/or UDP port 53 may be trapped within the IPSec front-end 102, such as by a kernel of the host operating system, and the message passed to Ethernet interface 402 along with a new ethertype value and a broadcast MAC address. According to one embodiment, the special address may be a loopback address.

FIG. 5B is a call diagram illustrating domain name resolution for a IPSec front-end according to one embodiment of the disclosure. A call flow 500 begins at call 502 with a IPSec front-end requesting name resolution of a name from the host 104. The call 502 may include the IPSec front-end 102 transmitting a DNS request to a special address described above. At call 504, the host 104 transmits a DNS request to a DNS server. The DNS request may pass transparently through the IPSec front-end 102, when policies on the IPSec front-end 102 specify DNS requests are not to be intercepted and encrypted according to the method of FIG. 2. At call 506, the DNS server replies to the host 104 with an address corresponding to the name. At call 508, the host 104 transmits the address to the IPSec front-end 102.

Because the IPSec front-end 102 strips IP headers, the host 104 may not be aware of settings on the network-side of the IPSec front-end 102. As a result, the host 104 may transmit packets that exceed a maximum transmission unit (MTU) size of the secure network.

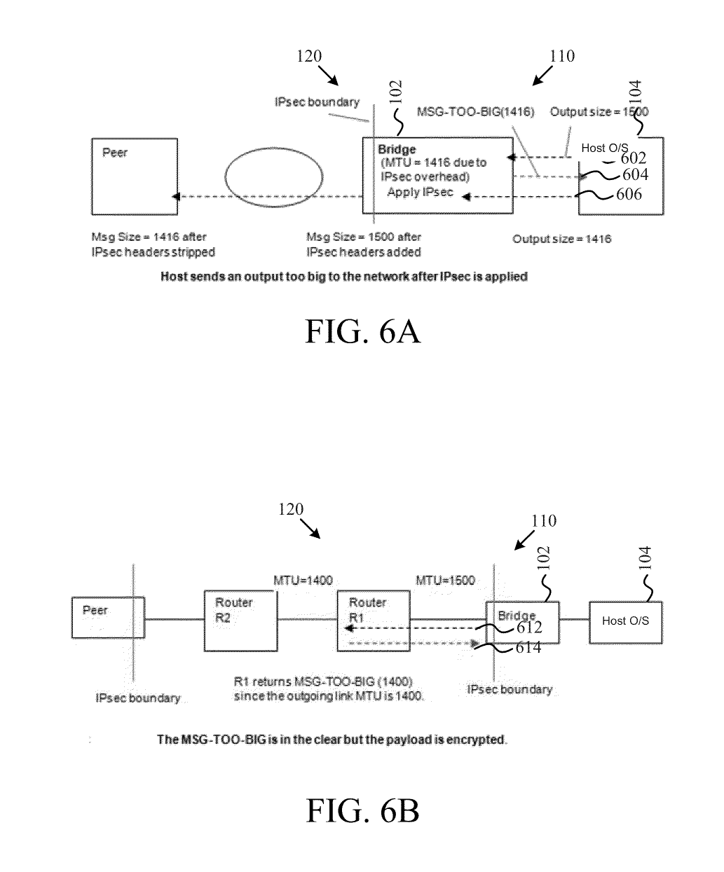

FIG. 6A is a block diagram illustrating a situation in which a host transmits a packet, which after processing by the IPSec front-end, would exceed a max transmission unit according to one embodiment of the disclosure. In FIG. 6A, a host-side network 110 and a network-side network 120 may have an MTU of 1500. However, when the host 104 transmits a packet with MTU of 1500 at call 602, the packet may be too large for transmission on the network-side network 120 due to additional space required for formatting the data as an IPsec packet. At call 604, the IPSec front-end 102 may transmit a message-too-big message to the host 104. At call 606, the host 104 may transmit data packets with a reduced size such as 1416.

Other networks between the IPSec front-end 102 and a peer may have smaller MTU values not known to the IPSec front-end 102 or the host 104. FIG. 6B is a block diagram illustrating a situation in which a host transmits a packet having a size exceeding a max transmission unit on a secure network according to one embodiment of the disclosure. At call 612, the IPSec front-end 102 may transmit a packet with size of 1500 to the network-side network 120. A device, such as a router, on the network-side network 120 may return an ICMP message-too-big message to the IPSec front-end 102, when the packet size exceeds an MTU for a network on the network-side network 120. The IPSec front-end 102 may update internal tables and transmit an ICMP message-too-big message to the host 104, when the host 104 attempts to transmit a packet that is too large for networks on the network-side network 120.

According to one embodiment, the IPSec front-end 102 may maintain PMTU data within IPsec security association (SA) tables and signal the host 104 an MTU size to use via an ICMP ‘too-big’ message. The IPSec front-end 102 may age and update path MTU (PMTU) size variables to discover if the PMTU is smaller than available by current network conditions. The host 104 may store MTU values on a connection-by-connection basis, based on messages received from the IPSec front-end 102. When an ICMP message-too-big is received by the host 104, the MTU value may be updated on the entry for a particular connection on an interface.

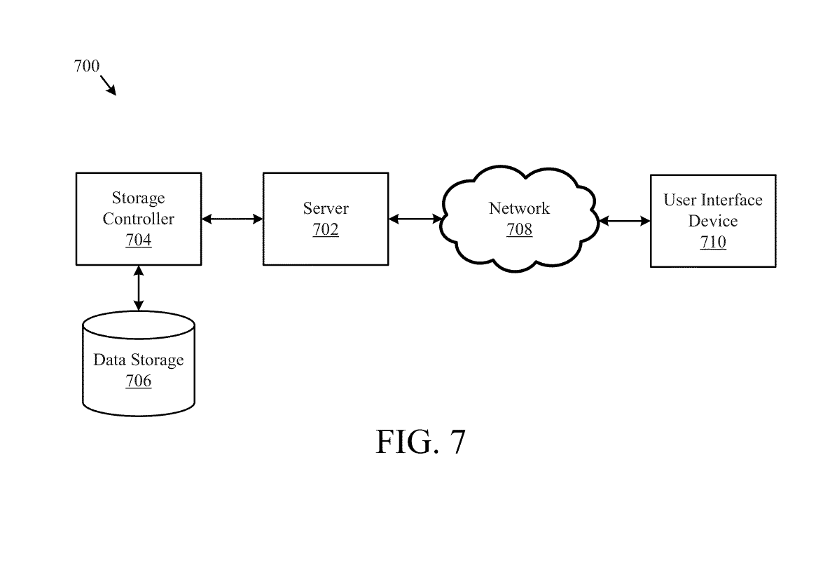

FIG. 7 illustrates one embodiment of a system 700 for an information system, including a system for hosting applications such as IPSec front-ends. The system 700 may include a server 702, a data storage device 706, a network 708, and a user interface device 710. In a further embodiment, the system 700 may include a storage controller 704, or storage server configured to manage data communications between the data storage device 706 and the server 702 or other components in communication with the network 708. In an alternative embodiment, the storage controller 704 may be coupled to the network 708.

In one embodiment, the user interface device 710 is referred to broadly and is intended to encompass a suitable processor-based device such as a desktop computer, a laptop computer, a personal digital assistant (PDA) or tablet computer, a smartphone or other a mobile communication device having access to the network 708. In a further embodiment, the user interface device 710 may access the Internet or other wide area or local area network to access a web application or web service hosted by the server 702 and may provide a user interface for enabling a user to modify policy information for a IPSec front-end.

The network 708 may facilitate communications of data between the server 702 and the user interface device 710. The network 708 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

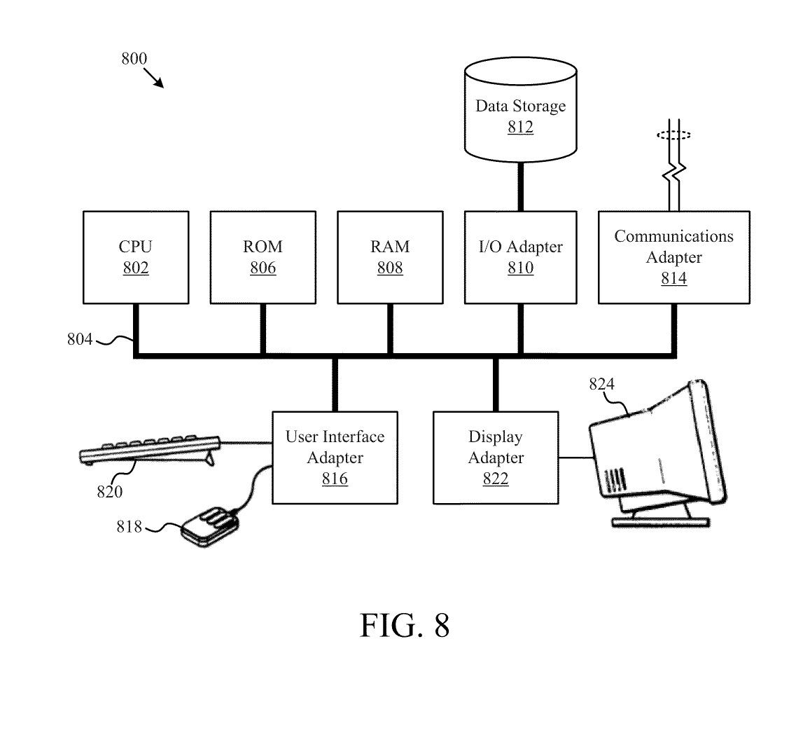

FIG. 8 illustrates a computer system 800 adapted according to certain embodiments of the server 702 and/or the user interface device 710. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 80( )also may include random access memory (RAM) 808, which may be synchronous RAM (SRAM), dynamic RAM (DRAW, synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

I/O adapter 810 may couple one or more storage devices 812, such as one or more of a hard drive, a solid state storage device, a flash drive, a compact disc (CD) drive, a yfloppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The user interface adapter 816 couples user input devices, such as a keyboard 820, a pointing device 818, and/or a touch screen (not shown) to the computer system 800. The keyboard 820 may be an on-screen keyboard displayed on a touch panel. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of the server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

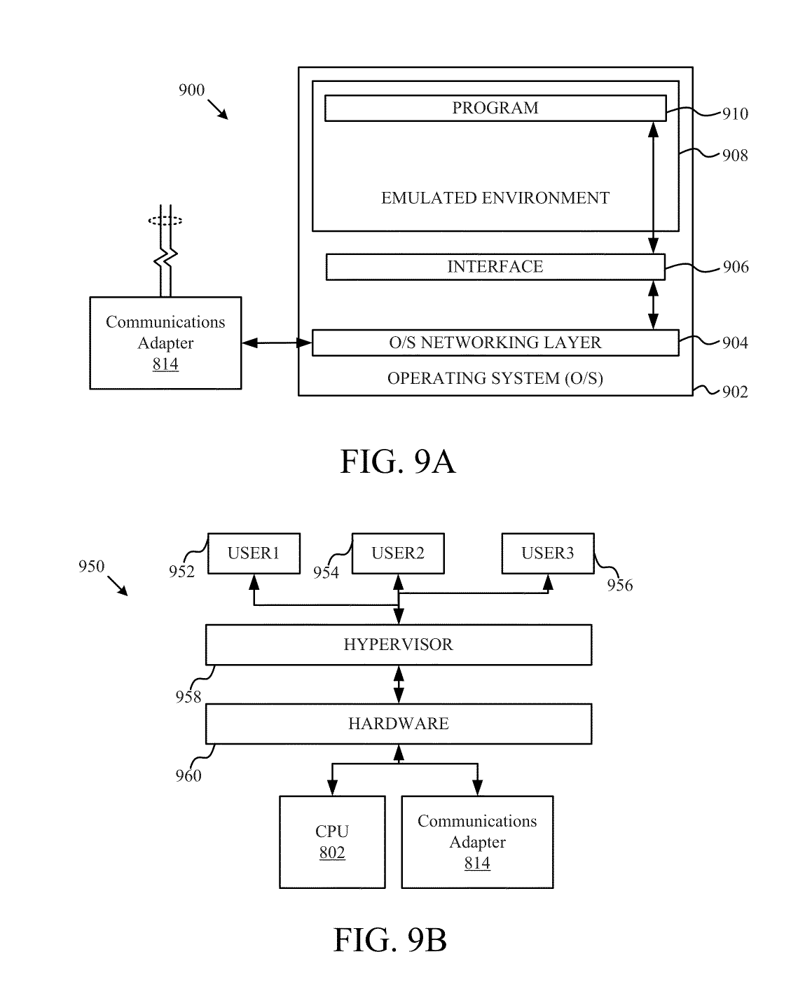

FIG. 9A is a block diagram illustrating a server hosting an emulated software environment for virtualization according to one embodiment of the disclosure. An operating system 902 executing on a server includes drivers for accessing hardware components, such as a networking layer 904 for accessing the communications adapter 814. The operating system 902 may be, for example, Linux. An emulated environment 908 in the operating system 902 executes a program 910, such as CPCommOS. The program 910 accesses the networking layer 904 of the operating system 902 through a non-emulated interface 906, such as XNIOP. The non-emulated interface 906 translates requests from the program 910 executing in the emulated environment 908 for the networking layer 904 of the operating system 902.

In another example, hardware in a computer system may be virtualized through a hypervisor. FIG. 9B is a block diagram illustrating a server hosting an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 9A. The hypervisor 958 may provide access to the hardware 960, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, by an IPSec front-end, clear text data formatted in an internet protocol (IP) packet from a host;
stripping, by the IPSec front-end, of network address information from the clear text data;
encrypting and authenticating, by the IPSec front-end, the clear text data; and
formatting, by the IPSec front-end, the encrypted data into an internet protocol security (IPsec) packet.

2. The method of claim 1, in which the step of formatting the IPsec packet comprises: storing a destination IP address from the IP packet; and applying the destination IP address to the IPsec packet.

3. The method of claim 2, in which the step of receiving the IP packet comprises determining whether to strip the IP packet, encrypt and authenticate the clear text data, and format the IPsec packet based, in part, on the destination IP address.

4. The method of claim 3, in which the step of determining comprises determining whether a policy specifies to encrypt and authenticate data to the destination IP address.

5. The method of claim 1, further comprising:
receiving, by the IPSec front-end, inbound encrypted and authenticated data formatted as an IPsec packet;
decrypting and authenticating, by the IPSec front-end, the inbound encrypted data; and
formatting, by the IPSec front-end, the unbound clear text data as an IP packet.

6. The method of claim 1, in which the host is executing in a virtualized environment, and in which the IPSec front-end is software executing on a server hosting the virtualized environment.

7. The method of claim 1, further comprising:
determining whether an IPsec connection exists after receiving the IP packets;
initiating, when no IPsec connection exists, an internet key exchange (IKE) protocol exchange to start the IPsec connection; and
transmitting the IPsec packet through the IPsec connection.

8. A computer program product, comprising:
a non-transitory computer-readable medium comprising:
code to receive clear text data formatted in an internet protocol (IP) packet from a host;
code to strip IP packet information from the clear text data;
code to encrypt the clear text data; and
code to format the encrypted data into an Internet protocol security IP (IPsec) packet.

9. The computer program product of claim 8, in which the medium further comprises: code to store a destination IP address from the IP packet; and code to apply the destination IP address to the IPsec packet.

10. The computer program product of claim 9, in which the medium further comprises code to determine whether to strip the IP packet, encrypt the dear text data, and format the IPsec packet based, in part, on the destination IP address.

11. The computer program product of claim 10, in which the medium further comprises code to determine whether a policy specifies to encrypt data to the destination IP address.

12. The computer program product of claim 8, in which the medium further comprises
code to receive inbound encrypted data formatted as an IPsec packet;
code to decrypt the inbound encrypted data; and
code to format the unbound clear text data as an IP packet.

13. The computer program product of claim 8, in which the medium further comprises
code to determine whether an IPsec connection exists after receiving the IP packets;
code to initiate, when no IPsec connection exists, an internet key exchange (IKE) protocol exchange to start the IPsec connection; and
code to transmit the IPsec packet through the IPsec connection.

14. An apparatus, comprising:
a memory;
a network interface; and
a processor coupled to the memory and the network interface, in which the processor is configured:
to receive, through the network interface, clear text data formatted in an internet protocol (IP) packet from a host;
to strip, through the network interface, IP packet information from the clear text data;
to encrypt, through the network interface, the clear text data; and
to format, through the network interface, the encrypted data into an internet protocol security IP (IPsec) packet.

15. The apparatus of claim 14, in which the processor is further configured:
to store a destination IP address from the IP packet in the memory; and
to apply the destination IP address to the IPsec packet.

16. The apparatus of claim 15, in which the processor is further configured to determine whether to strip the IP packet, encrypt the clear text data, and format the IPsec packet based, in part, on the destination IP address.

17. The apparatus of claim 16, in which the processor is further configured to determine whether a policy specifies to encrypt data sent to the destination IP address.

18. The apparatus of claim 14, in which the processor is further configured:
to receive, by the IPSec front-end, inbound encrypted data formatted as an IPsec packet;
to decrypt, by the IPSec front-end, the inbound encrypted data; and
to format, by the IPSec front-end, the unbound clear text data as an IP packet.

19. The apparatus of claim 14, in which the processor is further configured:
to determine whether an IPsec connection exists after receiving the IP packets;
to initiate, when no IPsec connection exists, an internet key exchange (IKE) protocol exchange to start the IPsec connection; and
to transmit the IPsec packet through the IPsec connection.

20. The apparatus of claim 14, in which the apparatus is a server, and the server is configured to execute the host in a virtualized environment.
